(19) United States
(12) Patent Application Publication
(10) Pub. No.: US 2024/0314544 A1
(43) Pub. Date: Sep. 19, 2024

(54) METHOD AND APPARATUS FOR REPORTING COHERENT MIMO CAPABILITY

(71) Applicant: QUALCOMM Incorporated, San Diego, CA (US)

(72) Inventors: Yiqing CAO, Beijing (CN); Timo Ville VINTOLA, San Diego, CA (US); Gene FONG, San Diego (AQ); Bin HAN, Beijing (CN); Peter GAAL, San Diego, CA (US); Gokul SRIDHARAN, Sunnyvale, CA (US); Enoch Shiao-Kuang LU, San Diego, CA (US); Alberto RICO ALVARINO, San Diego, CA (US); Juan MONTOJO, San Diego, CA (US); Yan LI, Beijing (CN); Zhimin DU, Beijing (CN)

(21) Appl. No.: 18/274,972

(22) PCT Filed: Sep. 18, 2021
(86) PCT No.: PCT/CN2021/119272

§ 371 Date: Jul. 28, 2023

(30) Foreign Application Priority Data
Mar. 11, 2021 (WO) PCT/CN2021/080149

(51) Int. Cl. H04W 8/24; H04B 7/0456; H04W 72/1268; H04W 72/51

(52) U.S. Cl. CPC H04W 8/24; H04B 7/0478; H04W 72/1268; H04W 72/51

(57) ABSTRACT

Aspects of the present disclosure include methods, apparatuses, and computer readable media for generating a capability message indicating a first coherence capability of a first frequency, a second coherence capability of a second frequency, and an uplink (UL) transmission (TX) switching coherence capability, transmitting the capability message to a base station, receiving UL scheduling information for transmitting first UL data using the first frequency and second UL data using the second frequency, and transmitting at least one of the first UL data or the second UL data based on the UL scheduling information and based on at least one of the first coherence capability, the second coherence capability, or the UL TX switching coherence capability.

### CROSS REFERENCE TO RELATED APPLICATION(S)

This application claims the benefit of PCT Application No. PCT/CN2021/080149, entitled “METHOD AND APPARATUS FOR REPORTING COHERENT MIMO CAPABILITY” and filed on Mar. 11, 2021, which is expressly incorporated by reference herein in its entirety.

### BACKGROUND

Aspects of the present disclosure relate generally to wireless communications, and more particularly, to apparatuses and methods for reporting coherent multiple-input multiple-output (MIMO) capability.

Wireless communication networks are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which may be referred to as new radio (NR)) is envisaged to expand and support diverse usage scenarios and applications with respect to current mobile network generations. In an aspect, 5G communications technology may include: enhanced mobile broadband addressing human-centric use cases for access to multimedia content, services and data: ultra-reliable-low latency communications (URLLC) with certain specifications for latency and reliability; and massive machine type communications, which may allow a very large number of connected devices and transmission of a relatively low volume of non-delay-sensitive information. As the demand for mobile broadband access continues to increase, however, further improvements in NR communications technology and beyond may be desired.

In a wireless communication network, a user equipment (UE) may be configured to transmit uplink (UL) information using coherent multiple-input multiple-output (MIMO) technology to a base station (BS). When utilizing the coherent MIMO technology for UL transmission, the UE may employ two or more antennas to transmit UL information using fully or partially coherent waveforms in two or more UL transmission (TX) chains. Coherent transmission has the advantage of increasing data rate and/or reliability. However, coherent transmission may require the two or more UL TX chains to maintain coherence. If one (or more) of the two or more UL TX chains is unable to maintain coherence, the codebook used by the UE may need to be updated. Therefore, improvements in reporting may be desirable.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Aspects of the present disclosure include methods by a user equipment (UE) for generating a capability message indicating a first coherence capability of a first frequency, a second coherence capability of a second frequency, and an uplink (UL) transmission (TX) switching coherence capability, transmitting the capability message to a base station, receiving UL scheduling information for transmitting first UL data using the first frequency and second UL data using the second frequency, and transmitting at least one of the first UL data or the second UL data based on the UL scheduling information and based on at least one of the first coherence capability, the second coherence capability, or the UL TX switching coherence capability.

Other aspects of the present disclosure include a user equipment (UE) having a memory comprising instructions, one or more processors configured to execute the instructions in the memory to generate a capability message indicating a first coherence capability of a first frequency, a second coherence capability of a second frequency, and an uplink (UL) transmission (TX) switching coherence capability, and a transceiver configured to: transmit the capability message to a base station, receive UL scheduling information for transmitting first UL data using the first frequency and second UL data using the second frequency, and transmit at least one of the first UL data or the second UL data based on the UL scheduling information and based on at least one of the first coherence capability, the second coherence capability, or the UL TX switching coherence capability.

An aspect of the present disclosure includes a user equipment (UE) including means for generating a capability message indicating a first coherence capability of a first frequency, a second coherence capability of a second frequency, and an uplink (UL) transmission (TX) switching coherence capability, means for transmitting the capability message to a base station, means for receiving UL scheduling information for transmitting first UL data using the first frequency and second UL data using the second frequency, and means for transmitting at least one of the first UL data or the second UL data based on the UL scheduling information and based on at least one of the first coherence capability, the second coherence capability, or the UL TX switching coherence capability.

Some aspects of the present disclosure include non-transitory computer readable media having instructions stored therein that, when executed by one or more processors of a user equipment (UE), cause the one or more processors to generate a capability message indicating a first coherence capability of a first frequency, a second coherence capability of a second frequency, and an uplink (UL) transmission (TX) switching coherence capability, transmit the capability message to a base station, receive UL scheduling information for transmitting first UL data using the first frequency and second UL data using the second frequency, and transmit at least one of the first UL data or the second UL data based on the UL scheduling information and based on at least one of the first coherence capability, the second coherence capability, or the UL TX switching coherence capability.

Aspects of the present disclosure include methods by a base station (BS) including receiving, from a user equipment (UE), a capability message indicating a first coherence capability of a first frequency, a second coherence capability of a second frequency, and an uplink (UL) transmission (TX) switching coherence capability, transmitting, to the UE, UL scheduling information for transmitting, by the UE, first UL data using the first frequency and second UL data using the second frequency, and receiving, from the UE, at least one of the first UL data or the second UL data based on the UL scheduling information and based on at least one of the first coherence capability, the second coherence capability, or the UL TX switching coherence capability.

Other aspects of the present disclosure include a base station (BS) having a memory comprising instructions, one or more processors configured to execute the instructions in the memory, and a transceiver configured to receive, from a user equipment (UE), a capability message indicating a first coherence capability of a first frequency, a second coherence capability of a second frequency, and an uplink (UL) transmission (TX) switching coherence capability, transmit, to the UE, UL scheduling information for transmitting, by the UE, first UL data using the first frequency and second UL data using the second frequency, and receive, from the UE, at least one of the first UL data or the second UL data based on the UL scheduling information and based on at least one of the first coherence capability, the second coherence capability, or the UL TX switching coherence capability.

An aspect of the present disclosure includes a base station (BS) including means for receiving, from a user equipment (UE), a capability message indicating a first coherence capability of a first frequency, a second coherence capability of a second frequency, and an uplink (UL) transmission (TX) switching coherence capability, means for transmitting, to the UE, UL scheduling information for transmitting, by the UE, first UL data using the first frequency and second UL data using the second frequency, and means for receiving, from the UE, at least one of the first UL data or the second UL data based on the UL scheduling information and based on at least one of the first coherence capability, the second coherence capability, or the UL TX switching coherence capability.

Some aspects of the present disclosure include non-transitory computer readable media having instructions stored therein that, when executed by one or more processors of a base station (BS), cause the one or more processors to receive, from a user equipment (UE), a capability message indicating a first coherence capability of a first frequency, a second coherence capability of a second frequency, and an uplink (UL) transmission (TX) switching coherence capability, transmit, to the UE, UL scheduling information for transmitting, by the UE, first UL data using the first frequency and second UL data using the second frequency, and receive, from the UE, at least one of the first UL data or the second UL data based on the UL scheduling information and based on at least one of the first coherence capability, the second coherence capability, or the UL TX switching coherence capability.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a diagram illustrating an example of a wireless communications system and an access network according to aspects of the present disclosure;

FIG. 2 is a schematic diagram of an example of a user equipment according to aspects of the present disclosure:

FIG. 3 is a schematic diagram of an example of a base station according to aspects of the present disclosure;

FIG. 4 shows an example of a diagram illustrating coherence capability reporting by a UE according to aspects of the present disclosure;

FIG. 5 illustrates an example of a method for reporting coherence capability according to aspects of the present disclosure; and

FIG. 6 illustrates an example of a method for transmitting codebook according to aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In one implementation, a user equipment (UE) may transmit uplink (UL) information using multiple-input multiple-output (MIMO) technology to a base station (BS). When utilizing the MIMO technology for UL transmission, the UE may employ two or more antennas and/or antenna ports to transmit the UL information using fully or partially coherent waveforms in two or more UL transmission (TX) chains. The UE may transmit the UL information using two or more frequencies. If the UE switches transmission frequencies for a UL TX chain, coherency may or may not be maintained.

In an aspect of the present disclosure, the UE may generate a capability message indicating a first coherence capability of a first frequency, a second coherence capability of a second frequency, and a UL TX switching coherence capability associated with the UL TX switching. UL TX switching occurs when a UL TX chain changes from transmitting at a first frequency to transmitting at a second frequency. The UE may transmit the capability message to the BS. In response, the BS may transmit an indication to the UE indicating the UE to use a fully coherent codebook, a partially coherent codebook, or a non-coherent codebook for transmitting the UL information. The BS may determine the codebook based on the received capability message and first coherence capability, the second coherence capability, and/or the UL TX switching coherence capability.

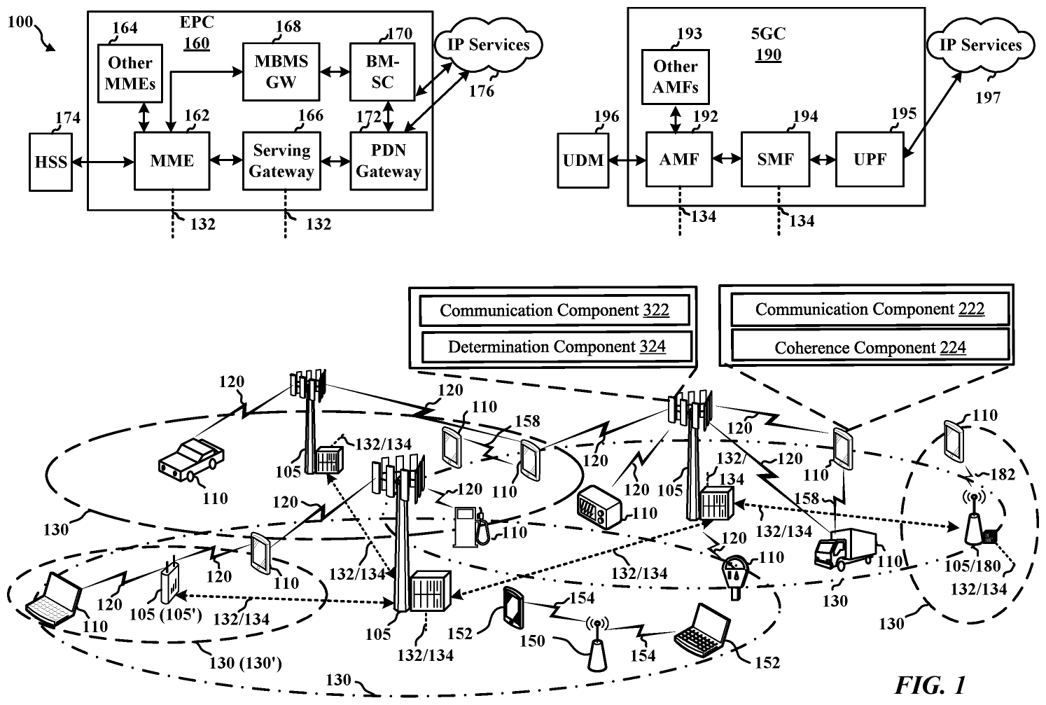

FIG. 1 is a diagram illustrating an example of a wireless communications system and an access network 100. The wireless communications system (also referred to as a wireless wide area network (WWAN)) includes at least one BS 105, UEs 110, an Evolved Packet Core (EPC) 160, and a 5G Core (5GC) 190. The BS 105 may include macro cells (high power cellular base station) and/or small cells (low power cellular base station). The macro cells include base stations. The small cells include femtocells, picocells, and microcells. In one implementation, the UE 110 may include a communication component 222 configured to communicate with the BS 105 via a cellular network, a Wi-Fi network, or other wireless and wired networks. The UE 110 may include a coherence component 224 configured to determine the coherence of one or more frequencies, frequency combinations, bands, and/or switching. In some implementations, the communication component 222 and/or the coherence component 224 may be implemented using hardware, software, or a combination of hardware and software. In some implementations, the BS 105 may include a communication component 322 configured to communicate with the UE 110. The BS 105 may include a determination component 324 configured to determine the codebook for the UE 110. In some implementations, the communication component 322 and/or the determination component 324 may be implemented using hardware, software, or a combination of hardware and software.

A BS 105 configured for 4G Long-Term Evolution (LTE) (collectively referred to as Evolved Universal Mobile Telecommunications System (UMTS) Terrestrial Radio Access Network (E-UTRAN)) may interface with the EPC 160 through backhaul links interfaces 132 (e.g., S1, X2, Internet Protocol (IP), or flex interfaces). A BS 105 configured for 5G NR (collectively referred to as Next Generation RAN (NG-RAN)) may interface with 5GC 190 through backhaul links interfaces 134 (e.g., S1, X2, Internet Protocol (IP), or flex interface). In addition to other functions, the BS 105 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The BS 105 may communicate directly or indirectly (e.g., through the EPC 160 or 5GC 190) with each other over the backhaul links interfaces 134. The backhaul links 132, 134 may be wired or wireless.

The BS 105 may wirelessly communicate with the UEs 110. Each of the BS 105 may provide communication coverage for a respective geographic coverage area 130. There may be overlapping geographic coverage areas 130. For example, the small cell 105′ may have a coverage area 130′ that overlaps the coverage area 130 of one or more macro BS 105. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the BS 105 and the UEs 110 may include uplink (UL) (also referred to as reverse link) transmissions from a UE 110 to a BS 105 and/or downlink (DL) (also referred to as forward link) transmissions from a BS 105 to a UE 110. The communication links 120 may use multiple-input and multiple-output (MIMO) antenna technology, including spatial multiplexing, beamforming, and/or transmit diversity. The communication links may be through one or more carriers. The BS 105/UEs 110 may use spectrum up to Y MHz (e.g., 5, 10, 15, 20, 100, 400, etc. MHz) bandwidth per carrier allocated in a carrier aggregation of up to a total of Yₓ MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 110 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 105′ may operate in a licensed and/or an unlicensed frequency spectrum. When operating in an unlicensed frequency spectrum, the small cell 105′ may employ NR and use the same 5 GHz unlicensed frequency spectrum as used by the Wi-Fi AP 150. The small cell 105′, employing NR in an unlicensed frequency spectrum, may boost coverage to and/or increase capacity of the access network.

A BS 105, whether a small cell 105′ or a large cell (e.g., macro base station), may include an eNB, gNodeB (gNB), or other type of base station. Some base stations, such as gNB 180 may operate in one or more frequency bands within the electromagnetic spectrum. The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “Sub-6 GHZ” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHZ” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW/near mmW radio frequency band has extremely high path loss and a short range. The mmW base station 180 may utilize beamforming 182 with the UE 110 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 110 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a packet switched (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the BS 105 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 110 and the 5GC 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The BS 105 may also be referred to as a gNB, Node B, evolved Node B (eNB), an access point, a base transceiver station, a radio base station, an access point, an access node, a radio transceiver, a NodeB, eNodeB (eNB), gNB, Home NodeB, a Home eNodeB, a relay, a transceiver function, a basic service set (BSS), an extended service set (ESS), a transmit reception point (TRP), or some other suitable terminology. The BS 105 provides an access point to the EPC 160 or 5GC 190 for a UE 110. Examples of UEs 110 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 110 may be referred to as IoT devices (e.g., parking meter, gas pump, toaster, vehicles, heart monitor, etc.). The UE 110 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

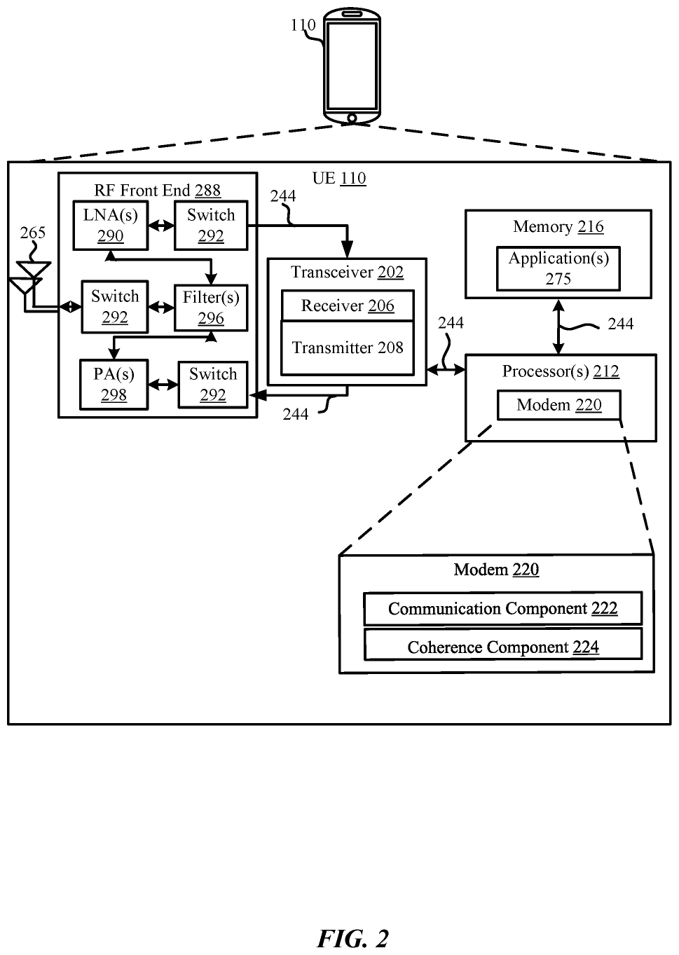

Referring to FIG. 2, one example of an implementation of the UE 110 may include a modem 220 having the communication component 222 and/or the coherence component 224. In one implementation, the UE 110 may include a communication component 222 configured to communicate with the BS 105 via a cellular network, a Wi-Fi network, or other wireless and wired networks. The UE 110 may include a coherence component 224 configured to determine the coherence of one or more frequencies, frequency combinations, bands, and/or switching.

In some implementations, the UE 110 may include a variety of components, including components such as one or more processors 212 and memory 216 and transceiver 202 in communication via one or more buses 244, which may operate in conjunction with the modem 220 and the communication component 222 to enable one or more of the functions described herein related to communicating with the BS 105. Further, the one or more processors 212, modem 220, memory 216, transceiver 202, radio frequency (RF) front end 288 and one or more antennas 265, may be configured to support voice and/or data calls (simultaneously or non-simultaneously) in one or more radio access technologies. The one or more antennas 265 may include one or more antennas, antenna elements and/or antenna arrays.

In an aspect, the one or more processors 212 may include the modem 220 that uses one or more modem processors. The various functions related to the communication component 222 and/or the coherence component 224 may be included in the modem 220 and/or processors 212 and, in an aspect, may be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiving device processor, or a transceiver processor associated with transceiver 202. Additionally, the modem 220 may configure the UE 110 along with the processors 212. In other aspects, some of the features of the one or more processors 212 and/or the modem 220 associated with the communication component 222 may be performed by transceiver 202.

The memory 216 may be configured to store data used and/or local versions of application 275. Also, the memory 216 may be configured to store data used herein and/or local versions of the communication component 222 and/or the coherence component 224, and/or one or more of the subcomponents being executed by at least one processor 212. Memory 216 may include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining the communication component 222 and/or the coherence component 224, and/or one or more of the subcomponents, and/or data associated therewith, when UE 110 is operating at least one processor 212 to execute the communication component 222 and/or the coherence component 224, and/or one or more of the subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a RF receiving device. In an aspect, the receiver 206 may receive signals transmitted by at least one BS 105. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 110 may include RF front end 288, which may operate in communication with one or more antennas 265 and transceiver 202 for receiving and transmitting radio transmissions, for example, wireless communications transmitted by at least one BS 105 or wireless transmissions transmitted by UE 110. RF front end 288 may be coupled with one or more antennas 265 and may include one or more low-noise amplifiers (LNAs) 290, one or more switches 292, one or more power amplifiers (PAS) 298, and one or more filters 296 for transmitting and receiving RF signals.

In an aspect, LNA 290 may amplify a received signal at a desired output level. In an aspect, each LNA 290 may have a specified minimum and maximum gain values. In an aspect, RF front end 288 may use one or more switches 292 to select a particular LNA 290 and the specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and the specified gain value based on a desired gain value for a particular application.

Also, for example, one or more filters 296 may be used by RF front end 288 to filter a received signal to obtain an input RF signal. Similarly, in an aspect, for example, a respective filter 296 may be used to filter an output from a respective PA 298 to produce an output signal for transmission. In an aspect, each filter 296 may be coupled with a specific LNA 290 and/or PA 298. In an aspect, RF front end 288 may use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 110 may communicate with, for example, one or more BS 105 or one or more cells associated with one or more BS 105. In an aspect, for example, the modem 220 may configure transceiver 202 to operate at a specified frequency and power level based on the UE configuration of the UE 110 and the communication protocol used by the modem 220.

In an aspect, the modem 220 may be a multiband-multimode modem, which may process digital data and communicate with transceiver 202 such that the digital data is sent and received using transceiver 202. In an aspect, the modem 220 may be multiband and be configured to support multiple frequency bands for a specific communications protocol. In an aspect, the modem 220 may be multimode and be configured to support multiple operating networks and communications protocols. In an aspect, the modem 220 may control one or more components of UE 110 (e.g., RF front end 288, transceiver 202) to enable transmission and/or reception of signals from the network based on a specified modem configuration. In an aspect, the modem configuration may be based on the mode of the modem and the frequency band in use. In another aspect, the modem configuration may be based on UE configuration information associated with UE 110 as provided by the network.

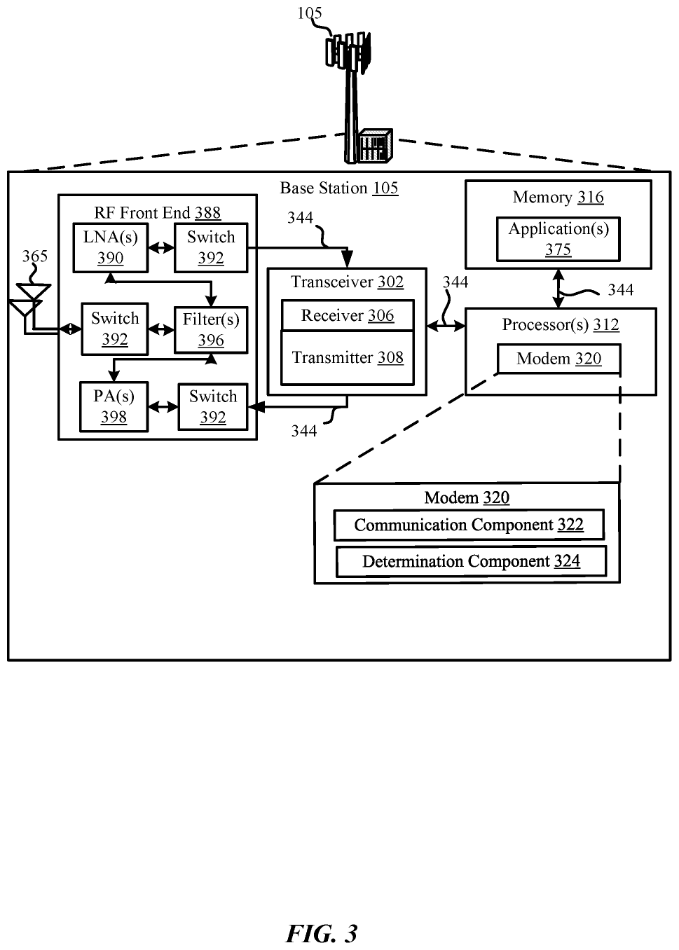

Referring to FIG. 3, one example of an implementation of the BS 105 may include a modem 320 having the communication component 322 and/or the determination component 324. In some implementations, the BS 105 may include a communication component 322 configured to communicate with the UE 110. The BS 105 may include a determination component 324 configured to determine the codebook for the UE 110.

In some implementations, the BS 105 may include a variety of components, including components such as one or more processors 312 and memory 316 and transceiver 302 in communication via one or more buses 344, which may operate in conjunction with the modem 320 and the communication component 322 to enable one or more of the functions described herein related to communicating with the UE 110. Further, the one or more processors 312, modem 320, memory 316, transceiver 302, RF front end 388 and one or more antennas 365, may be configured to support voice and/or data calls (simultaneously or non-simultaneously) in one or more radio access technologies.

In an aspect, the one or more processors 312 may include the modem 320 that uses one or more modem processors. The various functions related to the communication component 322 and/or the determination component 324 may be included in the modem 320 and/or processors 312 and, in an aspect, may be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiving device processor, or a transceiver processor associated with transceiver 302. Additionally, the modem 320 may configure the BS 105 and processors 312. In other aspects, some of the features of the one or more processors 312 and/or the modem 320 associated with the communication component 322 may be performed by transceiver 302.

The memory 316 may be configured to store data used herein and/or local versions of applications 375. Also, the memory 316 may be configured to store data used herein and/or local versions of the communication component 322 and/or the determination component 324, and/or one or more of the subcomponents being executed by at least one processor 312. Memory 316 may include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining the communication component 322 and/or the determination component 324, and/or one or more of the subcomponents, and/or data associated therewith, when the BS 105 is operating at least one processor 312 to execute the communication component 322 and/or the determination component 324, and/or one or more of the subcomponents.

Transceiver 302 may include at least one receiver 306 and at least one transmitter 308. The at least one receiver 306 may include hardware, firmware, and/or software code executable by a processor for receiving data, the code comprising instructions and being stored in a memory (e.g., computer-readable medium). The receiver 306 may be, for example, a RF receiving device. In an aspect, receiver 306 may receive signals transmitted by the UE 110. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, the BS 105 may include RF front end 388, which may operate in communication with one or more antennas 365 and transceiver 302 for receiving and transmitting radio transmissions, for example, wireless communications transmitted by other BS 105 or wireless transmissions transmitted by UE 110. RF front end 388 may be coupled with one or more antennas 365 and may include one or more low-noise amplifiers (LNAs) 390, one or more switches 392, one or more power amplifiers (PAS) 398, and one or more filters 396 for transmitting and receiving RF signals.

In an aspect, LNA 390 may amplify a received signal at a desired output level. In an aspect, each LNA 390 may have a specified minimum and maximum gain values. In an aspect, RF front end 388 may use one or more switches 392 to select a particular LNA 390 and the specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and the specified gain value based on a desired gain value for a particular application.

Also, for example, one or more filters 396 may be used by RF front end 388 to filter a received signal to obtain an input RF signal. Similarly, in an aspect, for example, a respective filter 396 may be used to filter an output from a respective PA 398 to produce an output signal for transmission. In an aspect, each filter 396 may be coupled with a specific LNA 390 and/or PA 398. In an aspect, RF front end 388 may use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that BS 105 may communicate with, for example, the UE 110 or one or more cells associated with one or more BS 105. In an aspect, for example, the modem 320 may configure transceiver 302 to operate at a specified frequency and power level based on the base station configuration of the BS 105 and the communication protocol used by the modem 320.

In an aspect, the modem 320 may be a multiband-multimode modem, which may process digital data and communicate with transceiver 302 such that the digital data is sent and received using transceiver 302. In an aspect, the modem 320 may be multiband and be configured to support multiple frequency bands for a specific communications protocol. In an aspect, the modem 320 may be multimode and be configured to support multiple operating networks and communications protocols. In an aspect, the modem 320 may control one or more components of the BS 105 (e.g., RF front end 388, transceiver 302) to enable transmission and/or reception of signals from the network based on a specified modem configuration. In an aspect, the modem configuration may be based on the mode of the modem and the frequency band in use. In another aspect, the modem configuration may be based on base station configuration associated with the BS 105.

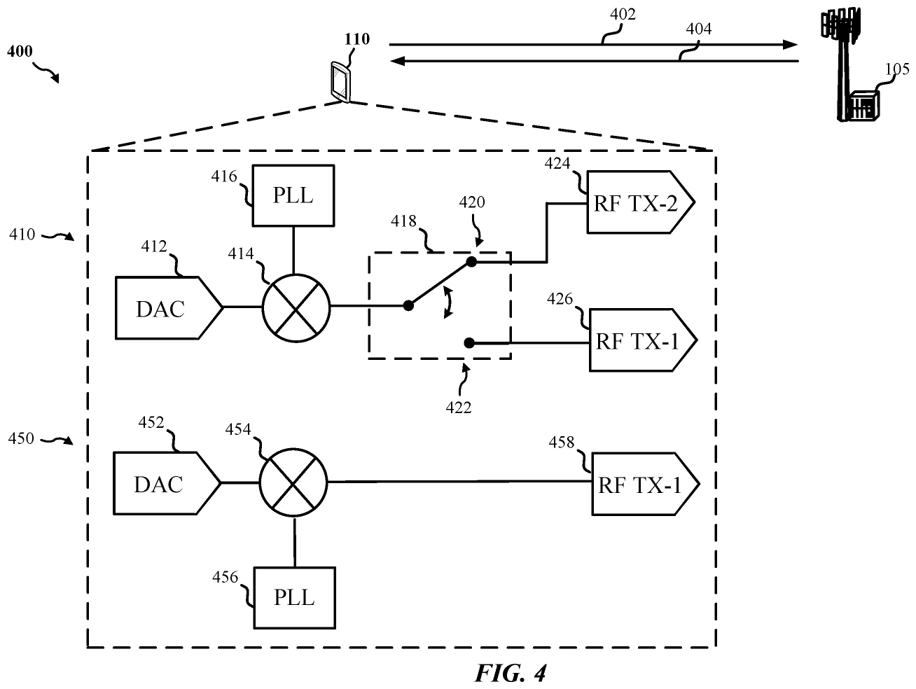

FIG. 4 shows an example of a diagram illustrating coherence capability reporting by a UE. A diagram 400 may illustrate a capability message 402 transmitted by the UE 110 to the BS 105 for UL coherent transmission. In some implementations, the UE 110 may include a first UL TX chain 450 and a second UL TX chain 410. Other number of UL TX chains may also be used by the UE 110 for UL transmission, such as more UL TX chains. A first DAC 412 may convert digital signals (e.g., bits and/or codewords) to analog signals (e.g., symbols). A mixer 414 may combine the analog signals and with the local oscillator signals from a first local oscillator 416 to produce combined signals. The mixer 414 may output the combined signals to a first RF resource 424 or a second RF resource 426 through a switch 418. Whether combined signals are output to the first RF resource 424 or the second RF resource 426 may depend on a position of the switch 418. If the switch 418 is in a first position 420, the combined signals may be output to the first RF resource 424. If the switch 418 is in a second position 422, the combined signals may be output to the second RF resource 426.

In some implementations, a second DAC 452 may convert digital signals (e.g., bits and/or codewords) to analog signals (e.g., symbols). A mixer 454 may combine the analog signals and with the local oscillator signals from a first local oscillator 456 to produce combined signals. The mixer 454 may output the combined signals to a third RF resource 458. The first RF resource 424, the second RF resource 426, and/or the third RF resource 458 may include power amplifiers, filters, antennas, antenna arrays, and/or other devices for transmitting RF signals at one or more frequencies and/or one or more frequency bands.

In certain implementations, the first local oscillator 416 may implement a first phase locked loop (PLL). The second local oscillator 456 may implement a second PLL. In one aspect, the first local oscillator 416 and the second local oscillator 456 may be the same local oscillator. In another aspect, the first local oscillator 416 and the second local oscillator 456 may be different local oscillators.

In an aspect of the present disclosure, UE 110 may receive UL scheduling information for transmitting UL information (e.g., UL data and/or UL control information). The UE 110 may schedule to transmit the UL information via the first UL TX chain 450 and/or the second UL TX chain 410. Prior to the UL transmission, the UE 110 may generate the capability message 402 indicating a first coherence capability of a first frequency RF TX-1 transmitted via the second RF resource 426 and/or the third RF resource 458. The capability message 402 may indicate a second coherence capability of a second frequency RF TX-2 transmitted via the first RF resource 424. The first coherence capability and/or the second coherence capability may be stored in the memory 216 of the UE 110. The first coherence capability and/or the second coherence capability may be determined during the manufacturing and/or testing of the UE 110. Alternatively and/or additionally, the first coherence capability and/or the second coherence capability may be determined based on the available RF resources (e.g., the second RF resource 426 and/or the third RF resource 458), the hardware of the UE 110, the processing capability of the UE 110, and/or other factors. Each of the first coherence capability and the second coherence capability may include a fully coherent transmission capability, a partially coherent transmission capability, and a non-coherent transmission capability. In other words, the UE 110 may be configured to transmit the UL information via the coherent multiple-input multiple-output (MIMO) technology. The UE 110 may employ the first RF resource 424, the second RF resource 426, and/or the third RF resource 458 to transmit UL information using fully or partially coherent waveforms in the first UL TX chain 450 and/or the second UL TX chain 410.

In an aspect of the present disclosure, the capability message 402 may indicate an UL TX switching coherence capability. The UL TX switching coherence capability may indicate whether the switching may cause the second UL TX chain 410 to maintain or lose transmission coherence. If the switching causes the second UL TX chain 410 to lose transmission coherence, the capability message 402 may indicate as such. As a result, even if the UE 110 supports fully and/or partial coherence of the first frequency RF TX-1 (indicated by the first coherence capability), the loss of transmission coherence during switching may mean that the UE 110 is unable to support coherent transmission via the first frequency RF TX-1.

In some implementations, the coherence capability may indicate the ability for a UE to transmit uplink information via coherent MIMO technology. A coherence capability associated with a frequency may indicate whether the UE is configured to transmit, at the frequency, uplink information using two or more beams that are fully phase locked, partially phase locked, or not phase locked. A coherence capability associated with the UL TX switching may indicate whether a UL TX chain is able to maintain coherency (with another UL TX chain) after switching from a frequency to a different frequency. The UL TX switching may be determined, at least partially, on whether the phase lock loop of the UL TX chain is able to recover coherency when experiencing jitter.

For example, if a UE is unable to transmit uplink information via coherent MIMO technology at a frequency, the coherence capability of the frequency may be indicated as non-coherent. As a result, the UE may only use a non-coherent codebook for UL transmission at the frequency. If the UE is able to transmit fully coherent uplink information, the coherence capability of the frequency may be indicated as fully coherent. Accordingly, the UE may be able to use a non-coherent codebook, a partially coherent codebook, or a fully coherent codebook for UL transmission at the frequency.

For example, if a UL TX chain of a UE is configured to recover coherency after switching from a frequency to another frequency, the coherence capability of the UL TX chain may be indicated as fully coherent or partially coherent, depending on the phase and/or power error after the switching.

For coherent UL MIMO, there may be a threshold difference between the measured relative power and a threshold phase errors between different antenna ports in any slot within the specified time window from the last transmitted sounding reference signal (SRS) on the same antenna ports, for the purpose of UL transmission (i.e., codebook or non-codebook usage) and those measured at that last SRS. For example, a threshold difference of relative power error may be 1 decibel (dB), 2 dB, 4 dB, 5 dB, or other values. A threshold difference of relative phase error may be 10 degrees, 20 degrees, 40 degrees, 50 degrees, or other values. The threshold requirement above may apply when the UL transmission power at each antenna port is larger than 0 dBm for SRS transmission and for the duration of time window (e.g., 20 milliseconds). In some instances, the threshold requirement above may require one or more of the following conditions: the UE is not signaled with a change in the number of SRS ports in SRS configuration or a change in physical uplink shared channel (PUSCH) configuration, the UE remains in discontinuous reception (DRX) active time (e.g., the UE does not enter DRX off time), no measurement gap occurs, no instances of SRS transmission with the usage antenna switching occurs or the UE is configured with UL TX switching, active bandwidth part (BWP) remains the same, Evolved-Universal Terrestrial Radio Access-New Radio dual connectivity (EN-DC) and/or carrier aggregation (CA) configuration is not changed for the UE (i.e., the UE is not configured or de-configured with primary secondary cell or secondary cell(s)).

In certain aspects of the present disclosure, the UE 110 may transmit the capability message 402, which includes the first coherence capability of the first frequency RF TX-1, the second coherence capability of the second frequency RF TX-2, and/or the UL TX switching coherence capability, to the BS 105. The BS 105 may receive the capability message 402, and transmit a configuration message 404 indicating a fully coherent codebook, a partially coherent codebook, or a non-coherent codebook to the UE 110. In response to receiving the configuration message, the UE 110 may transmit the UL information via the corresponding codebook indicated in the configuration message.

In some implementations, the UE 110 may transmit the capability message 402 via a radio resource control (RRC) message. For example, some or all of the capability message 402 may be transmitted via one or more of the following signals:
pusch-TransCoherence,
pusch-TransCoherence_TXSwitching_band_comb_1,
pusch-TransCoherence_TXSwitching_band_comb_2, . . .
pusch-TransCoherence_TXSwitching_band_comb_n.

Here n is a positive integer indicating a number of possible band combination for UL TX switching.

In some instances, if the configuration message 404 indicates the fully coherent codebook, the UE 110 may utilize the fully coherent codebook, the partially coherent codebook, and/or the non-coherent codebook for transmitting the UL information. If the configuration message 404 indicates the partially coherent codebook, the UE 110 may utilize the partially coherent codebook and/or the non-coherent codebook for transmitting the UL information. If the configuration message 404 indicates the non-coherent codebook, the UE 110 may utilize the non-coherent codebook for transmitting the UL information.

In a first example, the first frequency RF TX-1 and the second frequency RF TX-2 may not be configured for fully coherent UL transmission or partially coherent UL transmission. The UE 110 may be scheduled to switch from the first frequency RF TX-1 to the second frequency RF TX-2 in the second UL TX chain 410. The UE 110 may report the first coherent capability and the second coherent capability to the BS 105 in the capability message 402 (along with the UL TX switching coherence capability). Regardless of the UL TX switching coherence capability, the BS 105 may transmit the configuration message 404 indicating the non-coherent codebook for the UE 110 to transmit the UL information because neither the first frequency RF TX-1 nor the second frequency RF TX-2 is configured for fully coherent UL transmission or partially coherent UL transmission.

In a second example according to aspects of the present disclosure, the first local oscillator 416 and the second local oscillator 456 may be the same local oscillator. That is, the same local oscillator may output signals to both the first mixer 414 and the second mixer 454. The first frequency RF TX-1 and the second frequency RF TX-2 may be configured for fully coherent UL transmission and partially coherent UL transmission. The UE 110 may report the first coherent capability and the second coherent capability to the BS 105 in the capability message 402. The UE 110 may be scheduled to switch from the first frequency RF TX-1 to the second frequency RF TX-2 and/or from the second frequency RF TX-2 to the first frequency RF TX-1 in the second UL TX chain 410. The switching may cause the coherent transmission via the first frequency RF TX-1 on the second UL TX chain 410 to lose coherence because identical local oscillator signals are being sent to both the first mixer 414 and the second mixer 454. Any jitter caused by the switch 418 switching between the first position 420 and the second position 422 may only impact the first mixer 414 and not the second mixer 454. As a result, the UE 110 may transmit the capability message 402 including the UL TX switching coherence capability, which indicates that the switching process does not maintain coherence. Based on the capability message 402, the BS 105 may transmit the configuration message 404 indicating the non-coherent codebook for the UE 110 to transmit the UL information.

In a third example according to aspects of the present disclosure, the first local oscillator 416 and the second local oscillator 456 may be different oscillators. That is, the first local oscillator 416 may output signals to the first mixer 414 and the second local oscillator 456 may independently output signals to the second mixer 454. The first frequency RF TX-1 and the second frequency RF TX-2 may be configured for fully coherent UL transmission and partially coherent UL transmission. The UE 110 may report the first coherent capability and the second coherent capability to the BS 105 in the capability message 402. The UE 110 may be scheduled to switch from the first frequency RF TX-1 to the second frequency RF TX-2 and/or from the second frequency RF TX-2 to the first frequency RF TX-1 in the second UL TX chain 410. After switching from the second frequency RF TX-2 to the first frequency RF TX-1, the first PLL may restore coherence since the first PLL is configured to output signals independent from the second PLL. As a result, the UE 110 may transmit the capability message 402 including the UL TX switching coherence capability, which indicates that the switching process maintains coherence. Based on the capability message 402, the BS 105 may transmit the configuration message 404 indicating the fully coherent codebook or the partially coherent codebook for the UE 110 to transmit the UL information.

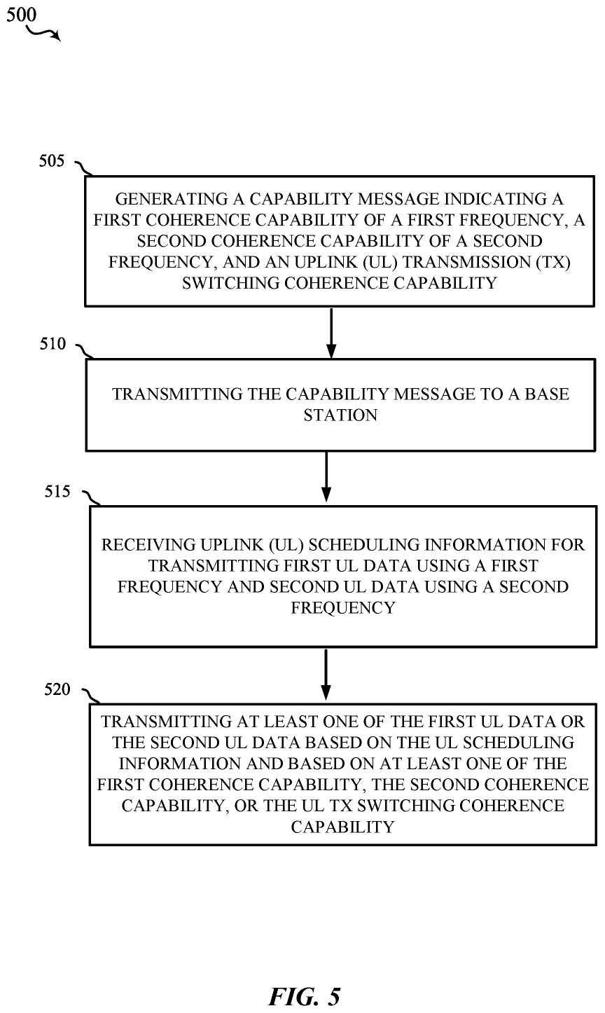

FIG. 5 illustrates an example of a method for reporting coherence capability. For example, a method 500 may be performed by the one or more of the processor 212, the memory 216, the applications 275, the modem 220, the transceiver 202, the receiver 206, the transmitter 208, the RF front end 288, the communication component 222 and/or the coherence component 224, and/or one or more other components of the UE 110 in the wireless communication network 100.

At block 505, the method 500 may generate a capability message indicating a first coherence capability of a first frequency, a second coherence capability of a second frequency, and an uplink (UL) transmission (TX) switching coherence capability. For example, the coherence component 224, the processor 212, the memory 216, and/or the applications 275 of the UE 110 may generate a capability message indicating a first coherence capability of a first frequency, a second coherence capability of a second frequency, and an uplink (UL) transmission (TX) switching coherence capability as described above.

In certain implementations, the coherence component 224, the processor 212, the memory 216, and/or the applications 275 may be configured to and/or may define means for generating a capability message indicating a first coherence capability of a first frequency, a second coherence capability of a second frequency, and an uplink (UL) transmission (TX) switching coherence capability.

At block 510, the method 500 may transmit the capability message to a base station. For example, the communication component 222, the transceiver 202, the receiver 206, the transmitter 208, the RF front end 288, the subcomponents of the RF front end 288, the processor 212, the memory 216, the modem 220, and/or the applications 275 of the UE 110 may transmit the capability message to a base station. The communication component 222 may send the digital signals to the transceiver 202 or the transmitter 208. The transceiver 202 or the transmitter 208 may convert the digital signals to electrical signals and send to the RF front end 288. The RF front end 288 may filter and/or amplify the electrical signals. The RF front end 288 may send the electrical signals as electro-magnetic signals via the one or more antennas 265.

In certain implementations, the communication component 222, the transceiver 202, the receiver 206, the transmitter 208, the RF front end 288, the subcomponents of the RF front end 288, the processor 212, the memory 216, the modem 220, and/or the applications 275 may be configured to and/or may define means for transmitting the capability message to a base station.

At block 515, the method 500 may receive uplink (UL) scheduling information for transmitting first UL data using the first frequency and second UL data using the second frequency. For example, the communication component 222, the transceiver 202, the receiver 206, the transmitter 208, the RF front end 288, the subcomponents of the RF front end 288, the processor 212, the memory 216, the modem 220, and/or the applications 275 of the UE 110 may receive uplink (UL) scheduling information for transmitting first UL data using the first frequency and second UL data using the second frequency as described above. The RF front end 288 may receive the electrical signals converted from electro-magnetic signals. The RF front end 288 may filter and/or amplify the electrical signals. The transceiver 202 or the receiver 206 may convert the electrical signals to digital signals, and send the digital signals to the communication component 222.

In certain implementations, the communication component 222, the transceiver 202, the receiver 206, the transmitter 208, the RF front end 288, the subcomponents of the RF front end 288, the processor 212, the memory 216, the modem 220, and/or the applications 275 may be configured to and/or may define means for receiving uplink (UL) scheduling information for transmitting first UL data using the first frequency and second UL data using the second frequency.

At block 520, the method 500 may transmit at least one of the first UL data or the second UL data based on the UL scheduling information and based on at least one of the first coherence capability, the second coherence capability, or the UL TX switching coherence capability. For example, the communication component 222, the transceiver 202, the receiver 206, the transmitter 208, the RF front end 288, the subcomponents of the RF front end 288, the processor 212, the memory 216, the modem 220, and/or the applications 275 of the UE 110 may transmit at least one of the first UL data or the second UL data based on the UL scheduling information and based on at least one of the first coherence capability, the second coherence capability, or the UL TX switching coherence capability. The communication component 222 may send the digital signals to the transceiver 202 or the transmitter 208. The transceiver 202 or the transmitter 208 may convert the digital signals to electrical signals and send to the RF front end 288. The RF front end 288 may filter and/or amplify the electrical signals. The RF front end 288 may send the electrical signals as electro-magnetic signals via the one or more antennas 265.

In certain implementations, the communication component 222, the transceiver 202, the receiver 206, the transmitter 208, the RF front end 288, the subcomponents of the RF front end 288, the processor 212, the memory 216, the modem 220, and/or the applications 275 may be configured to and/or may define means for transmitting at least one of the first UL data or the second UL data based on the UL scheduling information and based on at least one of the first coherence capability, the second coherence capability, or the UL TX switching coherence capability. For example, depending on the scheduling information received from the base station 105, the UE 110 may transmit only the first UL data, only the second UL data, or both the first UL data and the second UL data simultaneously.

Alternatively or additionally, the method 500 may further include any of the methods above, further comprising receiving, from the base station in response to the capability message, a configuration message indicating a non-coherent codebook for transmitting at least one of the first UL data or the second UL data, and wherein transmitting comprises transmitting at least one of the first UL data or the second UL data using the non-coherent codebook. The communication component 222, the transceiver 202, the receiver 206, the transmitter 208, the RF front end 288, the subcomponents of the RF front end 288, the processor 212, the memory 216, the modem 220, and/or the applications 275 may be configured to and/or may define means for receiving, from the base station in response to the capability message, a configuration message indicating a non-coherent codebook for transmitting at least one of the first UL data or the second UL data, and wherein transmitting comprises transmitting at least one of the first UL data or the second UL data using the non-coherent codebook.

Alternatively or additionally, the method 500 may further include any of the methods above, further comprising receiving, from the base station in response to the capability message, a configuration message indicating a fully coherent codebook for transmitting at least one of the first UL data or the second UL data, and wherein transmitting comprises transmitting at least one of the first UL data or the second UL data using the fully coherent codebook. The communication component 222, the transceiver 202, the receiver 206, the transmitter 208, the RF front end 288, the subcomponents of the RF front end 288, the processor 212, the memory 216, the modem 220, and/or the applications 275 may be configured to and/or may define means for receiving, from the base station in response to the capability message, a configuration message indicating a fully coherent codebook for transmitting at least one of the first UL data or the second UL data, and wherein transmitting comprises transmitting at least one of the first UL data or the second UL data using the fully coherent codebook.

Alternatively or additionally, the method 500 may further include any of the methods above, further comprising receiving, from the base station in response to the capability message, a configuration message indicating a partially coherent codebook for transmitting at least one of the first UL data or the second UL data, and wherein transmitting comprises transmitting at least one of the first UL data or the second UL data using the partially coherent codebook. The communication component 222, the transceiver 202, the receiver 206, the transmitter 208, the RF front end 288, the subcomponents of the RF front end 288, the processor 212, the memory 216, the modem 220, and/or the applications 275 may be configured to and/or may define means for receiving, from the base station in response to the capability message, a configuration message indicating a partially coherent codebook for transmitting at least one of the first UL data or the second UL data, and wherein transmitting comprises transmitting at least one of the first UL data or the second UL data using the partially coherent codebook.

Alternatively or additionally, the method 500 may further include any of the methods above, wherein each of the first coherence capability, the second coherence capability, and the UL TX switching coherence capability includes a fully coherent transmission capability, a partially coherent transmission capability, or a non-coherent transmission capability.

Alternatively or additionally, the method 500 may further include any of the methods above, wherein the non-coherent transmission capability is a default mode of transmission capability.

Alternatively or additionally, the method 500 may further include any of the methods above, wherein the first frequency includes a first plurality of frequencies or the second frequency includes a second plurality of frequencies.

Alternatively or additionally, the method 500 may further include any of the methods above, further comprising configuring a first UL TX chain 450 to transmit the first UL data using the first frequency, and configuring a second UL TX chain 410 to transmit the first UL data using the first frequency, transmit the second UL data using the second frequency, and switch from a first scheduled transmission of the first UL data to a second scheduled transmission of the second UL data or from the second scheduled transmission of the second UL data to the first scheduled transmission of the first UL data, wherein the switching maintains coherency in the second UL TX chain 410, wherein the capability message indicates a partially coherent transmission capability or a fully coherent transmission capability for the UL TX switching coherence capability. The coherence component 224, the processor 212, the memory 216, the modem 220, and/or the applications 275 may be configured to and/or define means for configuring a first UL TX chain 450 to transmit the first UL data using the first frequency, and configuring a second UL TX chain 410 to transmit the first UL data using the first frequency, transmit the second UL data using the second frequency, and switch from a first scheduled transmission of the first UL data to a second scheduled transmission of the second UL data or from the second scheduled transmission of the second UL data to the first scheduled transmission of the first UL data, wherein the switching maintains coherency in the second UL TX chain 410, wherein the capability message indicates a partially coherent transmission capability or a fully coherent transmission capability for the UL TX switching coherence capability.

Alternatively or additionally, the method 500 may further include any of the methods above, further comprising configuring a first UL TX chain 450 to transmit the first UL data using the first frequency, and configuring a second UL TX chain 410 to transmit the first UL data using the first frequency, transmit the second UL data using the second frequency, and switch from a first scheduled transmission of the first UL data to a second scheduled transmission of the second UL data or from the second scheduled transmission of the second UL data to the first scheduled transmission of the first UL data, wherein the switching causes a loss in coherency in the second UL TX chain 410, wherein the capability message indicates a non-coherent transmission capability for the UL TX switching coherence capability. The coherence component 224, the processor 212, the memory 216, the modem 220, and/or the applications 275 may be configured to and/or define means for configuring a first UL TX chain 450 to transmit the first UL data using the first frequency, and configuring a second UL TX chain 410 to transmit the first UL data using the first frequency, transmit the second UL data using the second frequency, and switch from a first scheduled transmission of the first UL data to a second scheduled transmission of the second UL data or from the second scheduled transmission of the second UL data to the first scheduled transmission of the first UL data, wherein the switching causes a loss in coherency in the second UL TX chain 410, wherein the capability message indicates a non-coherent transmission capability for the UL TX switching coherence capability.

Alternatively or additionally, the method 500 may further include any of the methods above, further comprising generating a UL TX switching capability indicating whether a first UL TX chain 450 or a second UL TX chain 410 is configured for UL TX switching, and transmitting the UL TX switching capability to the base station. The coherence component 224, the processor 212, the memory 216, the modem 220, and/or the applications 275 may be configured to and/or define means for generating a UL TX switching capability indicating whether a first UL TX chain 450 or a second UL TX chain 410 is configured for UL TX switching, and transmitting the UL TX switching capability to the base station.

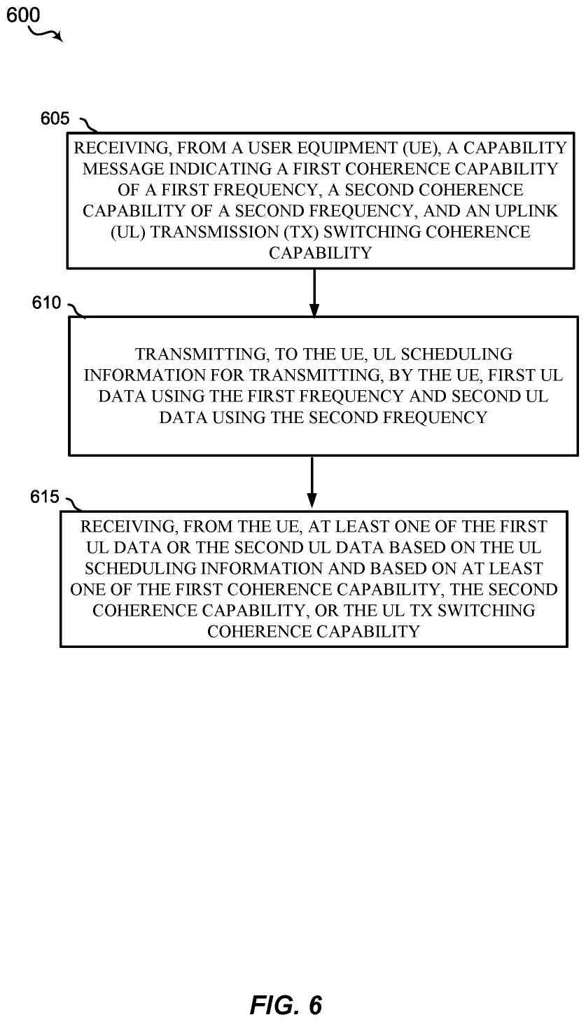

FIG. 6 illustrates an example of a method for indicating coherence codebook. For example, a method 600 may be performed by the one or more of the processor 312, the memory 316, the applications 375, the modem 320, the transceiver 302, the receiver 306, the transmitter 308, the RF front end 388, the communication component 322 and/or the determination component 324, and/or one or more other components of the base station 105 in the wireless communication network 100.

At block 605, the method 600 may receive, from a user equipment (UE), a capability message indicating a first coherence capability of a first frequency, a second coherence capability of a second frequency, and an uplink (UL) transmission (TX) switching coherence capability. For example, the determination component 324, the processor 312, the memory 316, and/or the applications 375 of the base station 105 may receive, from a UE, a capability message indicating a first coherence capability of a first frequency, a second coherence capability of a second frequency, and an uplink (UL) transmission (TX) switching coherence capability as described above. The RF front end 388 may receive the electrical signals converted from electro-magnetic signals. The RF front end 388 may filter and/or amplify the electrical signals. The transceiver 302 or the receiver 306 may convert the electrical signals to digital signals, and send the digital signals to the communication component 322 and/or the determination component 324.

In certain implementations, the determination component 324, the processor 312, the memory 316, and/or the applications 375 may be configured to and/or may define means for receiving, from a UE, a capability message indicating a first coherence capability of a first frequency, a second coherence capability of a second frequency, and an uplink (UL) transmission (TX) switching coherence capability.

At block 610, the method 600 may transmit, to the UE, UL scheduling information for transmitting, by the UE, first UL data using the first frequency and second UL data using the second frequency. For example, the communication component 322, the transceiver 302, the receiver 306, the transmitter 308, the RF front end 388, the subcomponents of the RF front end 388, the processor 312, the memory 316, the modem 320, and/or the applications 375 of the base station 105 may transmit, to the UE, UL scheduling information for transmitting, by the UE, first UL data using the first frequency and second UL data using the second frequency as described above. The communication component 322 may send the digital signals to the transceiver 302 or the transmitter 308. The transceiver 302 or the transmitter 308 may convert the digital signals to electrical signals and send to the RF front end 388. The RF front end 388 may filter and/or amplify the electrical signals. The RF front end 388 may send the electrical signals as electro-magnetic signals via the one or more antennas 365.

In certain implementations, the communication component 322, the transceiver 302, the receiver 306, the transmitter 308, the RF front end 388, the subcomponents of the RF front end 388, the processor 312, the memory 316, the modem 320, and/or the applications 375 may be configured to and/or may define means for transmitting, to the UE, UL scheduling information for transmitting, by the UE, first UL data using the first frequency and second UL data using the second frequency.

At block 615, the method 600 may receive, from the UE, at least one of the first UL data or the second UL data based on the scheduling information and based on at least one of the first coherence capability, the second coherence capability, or the UL TX switching coherence capability. For example, the communication component 322, the transceiver 302, the receiver 306, the transmitter 308, the RF front end 388, the subcomponents of the RF front end 388, the processor 312, the memory 316, the modem 320, and/or the applications 375 of the base station 105 may receive, from the UE, at least one of the first UL data or the second UL data based on the scheduling information and based on at least one of the first coherence capability, the second coherence capability, or the UL TX switching coherence capability. The RF front end 388 may receive the electrical signals converted from electro-magnetic signals. The RF front end 388 may filter and/or amplify the electrical signals. The transceiver 302 or the receiver 306 may convert the electrical signals to digital signals, and send the digital signals to the communication component 322 and/or the determination component 324.

In certain implementations, the determination component 324, the processor 312, the memory 316, and/or the applications 375 may be configured to and/or may define means for receiving, from the UE, at least one of the first UL data or the second UL data based on the scheduling information and based on at least one of the first coherence capability, the second coherence capability, or the UL TX switching coherence capability. For example, depending on the scheduling information transmitted to the UE 110, the base station 105 may receive only the first UL data, only the second UL data, or both the first UL data and the second UL data simultaneously.

Alternatively or additionally, the method 600 may further include transmitting, to the UE, in response to the capability message, a configuration message indicating a non-coherent codebook for transmitting at least one of the first UL data or the second UL data. For example, the communication component 322, the transceiver 302, the receiver 306, the transmitter 308, the RF front end 388, the subcomponents of the RF front end 388, the processor 312, the memory 316, the modem 320, and/or the applications 375 of the base station 105 may transmit, to the UE in response to the capability message, a configuration message indicating a non-coherent codebook for transmitting at least one of the first UL data or the second UL data as described above. The communication component 322 may send the digital signals to the transceiver 302 or the transmitter 308. The transceiver 302 or the transmitter 308 may convert the digital signals to electrical signals and send to the RF front end 388. The RF front end 388 may filter and/or amplify the electrical signals. The RF front end 388 may send the electrical signals as electro-magnetic signals via the one or more antennas 365.

In certain implementations, the communication component 322, the transceiver 302, the receiver 306, the transmitter 308, the RF front end 388, the subcomponents of the RF front end 388, the processor 312, the memory 316, the modem 320, and/or the applications 375 may be configured to and/or may define means for transmitting, to the UE, in response to the capability message, a configuration message indicating a non-coherent codebook for transmitting at least one of the first UL data or the second UL data.

Alternatively or additionally, the method 600 may include receiving at least one of the first UL data or the second UL data using the non-coherent codebook. For example, the determination component 324, the processor 312, the memory 316, and/or the applications 375 of the base station 105 may receive at least one of the first UL data or the second UL data using the non-coherent codebook as described above. The RF front end 388 may receive the electrical signals converted from electro-magnetic signals. The RF front end 388 may filter and/or amplify the electrical signals. The transceiver 302 or the receiver 306 may convert the electrical signals to digital signals, and send the digital signals to the communication component 322 and/or the determination component 324.

In certain implementations, the determination component 324, the processor 312, the memory 316, and/or the applications 375 may be configured to and/or may define means for receiving at least one of the first UL data or the second UL data using the non-coherent codebook.

Alternatively or additionally, the method 600 may further include transmitting, to the UE, in response to the capability message, a configuration message indicating a fully coherent codebook for transmitting at least one of the first UL data or the second UL data. For example, the communication component 322, the transceiver 302, the receiver 306, the transmitter 308, the RF front end 388, the subcomponents of the RF front end 388, the processor 312, the memory 316, the modem 320, and/or the applications 375 of the base station 105 may transmit, to the UE in response to the capability message, a configuration message indicating a fully coherent codebook for transmitting at least one of the first UL data or the second UL data as described above. The communication component 322 may send the digital signals to the transceiver 302 or the transmitter 308. The transceiver 302 or the transmitter 308 may convert the digital signals to electrical signals and send to the RF front end 388. The RF front end 388 may filter and/or amplify the electrical signals. The RF front end 388 may send the electrical signals as electro-magnetic signals via the one or more antennas 365.

In certain implementations, the communication component 322, the transceiver 302, the receiver 306, the transmitter 308, the RF front end 388, the subcomponents of the RF front end 388, the processor 312, the memory 316, the modem 320, and/or the applications 375 may be configured to and/or may define means for transmitting, to the UE, in response to the capability message, a configuration message indicating a fully coherent codebook for transmitting at least one of the first UL data or the second UL data.

Alternatively or additionally, the method 600 may include receiving at least one of the first UL data or the second UL data using the fully coherent codebook. For example, the determination component 324, the processor 312, the memory 316, and/or the applications 375 of the base station 105 may receive at least one of the first UL data or the second UL data using the fully coherent codebook as described above. The RF front end 388 may receive the electrical signals converted from electro-magnetic signals. The RF front end 388 may filter and/or amplify the electrical signals. The transceiver 302 or the receiver 306 may convert the electrical signals to digital signals, and send the digital signals to the communication component 322 and/or the determination component 324.

In certain implementations, the determination component 324, the processor 312, the memory 316, and/or the applications 375 may be configured to and/or may define means for receiving at least one of the first UL data or the second UL data using the fully coherent codebook.

Alternatively or additionally, the method 600 may further include transmitting, to the UE, in response to the capability message, a configuration message indicating a partially coherent codebook for transmitting at least one of the first UL data or the second UL data. For example, the communication component 322, the transceiver 302, the receiver 306, the transmitter 308, the RF front end 388, the subcomponents of the RF front end 388, the processor 312, the memory 316, the modem 320, and/or the applications 375 of the base station 105 may transmit, to the UE in response to the capability message, a configuration message indicating a partially coherent codebook for transmitting at least one of the first UL data or the second UL data as described above. The communication component 322 may send the digital signals to the transceiver 302 or the transmitter 308. The transceiver 302 or the transmitter 308 may convert the digital signals to electrical signals and send to the RF front end 388. The RF front end 388 may filter and/or amplify the electrical signals. The RF front end 388 may send the electrical signals as electro-magnetic signals via the one or more antennas 365.

In certain implementations, the communication component 322, the transceiver 302, the receiver 306, the transmitter 308, the RF front end 388, the subcomponents of the RF front end 388, the processor 312, the memory 316, the modem 320, and/or the applications 375 may be configured to and/or may define means for transmitting, to the UE, in response to the capability message, a configuration message indicating a partially coherent codebook for transmitting at least one of the first UL data or the second UL data.

Alternatively or additionally, the method 600 may include receiving at least one of the first UL data or the second UL data using the partially coherent codebook. For example, the determination component 324, the processor 312, the memory 316, and/or the applications 375 of the base station 105 may receive at least one of the first UL data or the second UL data using the partially coherent codebook as described above. The RF front end 388 may receive the electrical signals converted from electro-magnetic signals. The RF front end 388 may filter and/or amplify the electrical signals. The transceiver 302 or the receiver 306 may convert the electrical signals to digital signals, and send the digital signals to the communication component 322 and/or the determination component 324.

In certain implementations, the determination component 324, the processor 312, the memory 316, and/or the applications 375 may be configured to and/or may define means for receiving at least one of the first UL data or the second UL data using the partially coherent codebook.

In certain implementations, the non-coherent transmission capability is a default mode of transmission capability.

In certain implementations, the first frequency includes a first plurality of frequencies: or the second frequency includes a second plurality of frequencies.

In certain implementations, a first UL TX chain 450 of the UE 110 is configured to transmit the first UL data using the first frequency; and a second UL TX chain 410 of the UE 110 is configured to: transmit the first UL data using the first frequency, transmit the second UL data using the second frequency, and switch from a first scheduled transmission of the first UL data to a second scheduled transmission of the second UL data or from the second scheduled transmission of the second UL data to the first scheduled transmission of the first UL data, wherein the switching maintains coherency in the second UL TX chain 410; and wherein the capability message indicates a partially coherent transmission capability or a fully coherent transmission capability for the UL TX switching coherence capability.

In certain implementations, a first UL TX chain 450 of the UE 110 is configured to transmit the first UL data using the first frequency; and a second UL TX chain 410 of the UE 110 is configured to: transmit the first UL data using the first frequency, transmit the second UL data using the second frequency, and switch from a first scheduled transmission of the first UL data to a second scheduled transmission of the second UL data or from the second scheduled transmission of the second UL data to the first scheduled transmission of the first UL data, wherein the switching causes a loss in coherency in the second UL TX chain 410; and wherein the capability message indicates a non-coherent transmission capability for the UL TX switching coherence capability.

Alternatively or additionally, the method 600 may include receiving, from the UE, an UL TX switching capability indicating whether a first UL TX chain or a second UL TX chain is configured for UL TX switching. For example, the determination component 324, the processor 312, the memory 316, and/or the applications 375 of the base station 105 may receive, from the UE 110, an UL TX switching capability indicating whether a first UL TX chain 450 or a second UL TX chain 410 is configured for UL TX switching as described above. The RF front end 388 may receive the electrical signals converted from electro-magnetic signals. The RF front end 388 may filter and/or amplify the electrical signals. The transceiver 302 or the receiver 306 may convert the electrical signals to digital signals, and send the digital signals to the communication component 322 and/or the determination component 324.

In certain implementations, the determination component 324, the processor 312, the memory 316, and/or the applications 375 may be configured to and/or may define means for receiving, from the UE, an UL TX switching capability indicating whether a first UL TX chain 450 or a second UL TX chain 410 is configured for UL TX switching.

In certain aspects, a user equipment (UE) includes a processor (e.g., the one or more processors 212 in FIG. 2) and an interface (e.g., the one or more buses 244 in FIG. 2), wherein the processor is configured to: generate a capability message indicating a first coherence capability of a first frequency, a second coherence capability of a second frequency, and an uplink (UL) transmission (TX) switching coherence capability: output, via the interface, the capability message for transmission to a base station: obtain, via the interface, UL scheduling information received from the base station for transmitting first UL data using the first frequency and second UL data using the second frequency; and output, via the interface, for transmission to the base station, at least one of the first UL data or the second UL data based on the scheduling information and based on at least one of the first coherence capability, the second coherence capability, or the UL TX switching coherence capability.

In certain aspects, a base station includes a processor (e.g., the one or more processors 312 in FIG. 3) and an interface (e.g., the one or more buses 344 in FIG. 3), wherein the processor is configured to: obtain, via the interface, a capability message received from a user equipment (UE) indicating a first coherence capability of a first frequency, a second coherence capability of a second frequency, and an uplink (UL) transmission (TX) switching coherence capability: output, via the interface, for transmission to the UE, UL scheduling information for transmitting, by the UE, first UL data using the first frequency and second UL data using the second frequency; and obtain, via the interface, at least one of the first UL data or the second UL data received from the UE based on the scheduling information and based on at least one of the first coherence capability, the second coherence capability, or the UL TX switching coherence capability.

### ADDITIONAL ASPECTS

Aspect 1: A method of wireless communication by a user equipment (UE) in a network, comprising: generating a capability message indicating a first coherence capability of a first frequency, a second coherence capability of a second frequency, and an uplink (UL) transmission (TX) switching coherence capability: transmitting the capability message to a base station: receiving UL scheduling information for transmitting first UL data using the first frequency and second UL data using the second frequency; and transmitting at least one of the first UL data or the second UL data based on the UL scheduling information and based on at least one of the first coherence capability, the second coherence capability, or the UL TX switching coherence capability.

Aspect 2: The method of Aspect 1, further comprising: receiving, from the base station in response to the capability message, a configuration message indicating a non-coherent codebook for transmitting at least one of the first UL data or the second UL data; and wherein transmitting comprises transmitting at least one of the first UL data or the second UL data using the non-coherent codebook.

Aspect 3: The method of Aspect 1, further comprising: receiving, from the base station in response to the capability message, a configuration message indicating a fully coherent codebook for transmitting at least one of the first UL data or the second UL data; and wherein transmitting comprises transmitting at least one of the first UL data or the second UL data using the fully coherent codebook.

Aspect 4: The method of Aspect 1, further comprising: receiving, from the base station in response to the capability message, a configuration message indicating a partially coherent codebook for transmitting at least one of the first UL data or the second UL data; and wherein transmitting comprises transmitting at least one of the first UL data or the second UL data using the partially coherent codebook.

Aspect 5: The method of any one of Aspects 1 to 4, wherein: each of the first coherence capability, the second coherence capability, and the UL TX switching coherence capability includes a fully coherent transmission capability, a partially coherent transmission capability, or a non-coherent transmission capability.

Aspect 6: The method of Aspect 5, wherein: the non-coherent transmission capability is a default mode of transmission capability.

Aspect 7: The method of any one of Aspects 1 to 6, wherein: the first frequency includes a first plurality of frequencies: or the second frequency includes a second plurality of frequencies.

Aspect 8: The method of any one of Aspects 1 to 7, further comprising: configuring a first UL TX chain to transmit the first UL data using the first frequency; and configuring a second UL TX chain to: transmit the first UL data using the first frequency, transmit the second UL data using the second frequency, and switch from a first scheduled transmission of the first UL data to a second scheduled transmission of the second UL data or from the second scheduled transmission of the second UL data to the first scheduled transmission of the first UL data, wherein the switching maintains coherency in the second UL TX chain; wherein the capability message indicates a partially coherent transmission capability or a fully coherent transmission capability for the UL TX switching coherence capability.

Aspect 9: The method of any one of Aspects 1 to 7, further comprising: configuring a first UL TX chain to transmit the first UL data using the first frequency; and configuring a second UL TX chain to: transmit the first UL data using the first frequency, transmit the second UL data using the second frequency, and switch from a first scheduled transmission of the first UL data to a second scheduled transmission of the second UL data or from the second scheduled transmission of the second UL data to the first scheduled transmission of the first UL data, wherein the switching causes a loss in coherency in the second UL TX chain: wherein the capability message indicates a non-coherent transmission capability for the UL TX switching coherence capability.

Aspect 10: The method of any one of Aspects 1 to 9, further comprising: generating a UL TX switching capability indicating whether a first UL TX chain or a second UL TX chain is configured for UL TX switching; and transmitting the UL TX switching capability to the base station.

Aspect 11: A method of wireless communication by a base station comprising: receiving, from a user equipment (UE), a capability message indicating a first coherence capability of a first frequency, a second coherence capability of a second frequency, and an uplink (UL) transmission (TX) switching coherence capability: transmitting, to the UE, UL scheduling information for transmitting, by the UE, first UL data using the first frequency and second UL data using the second frequency; and receiving, from the UE, at least one of the first UL data or the second UL data based on the UL scheduling information and based on at least one of the first coherence capability, the second coherence capability, or the UL TX switching coherence capability.

Aspect 12: The method of Aspect 11, further comprising: transmitting, to the UE, in response to the capability message, a configuration message indicating a non-coherent codebook for transmitting at least one of the first UL data or the second UL data; and wherein receiving at least one of the first UL data or the second UL data comprises receiving at least one of the first UL data or the second UL using the non-coherent codebook.

Aspect 13: The method of Aspect 11, further comprising: transmitting, to the UE, in response to the capability message, a configuration message indicating a fully coherent codebook for transmitting at least one of the first UL data or the second UL data; and wherein receiving at least one of the first UL data or the second UL data comprises receiving at least one of the first UL data or the second UL data using the fully coherent codebook.

Aspect 14: The method of Aspect 11, further comprising: transmitting, to the UE, in response to the capability message, a configuration message indicating a partially coherent codebook for transmitting at least one of the first UL data or the second UL data; and wherein receiving at least one of the first UL data or the second UL data comprises receiving at least one of the first UL data or the second UL data using the partially coherent codebook.

Aspect 15: The method of any one of Aspects 11 to 14, wherein: each of the first coherence capability, the second coherence capability, and the UL TX switching coherence capability includes a fully coherent transmission capability, a partially coherent transmission capability, or a non-coherent transmission capability.

Aspect 16: The method of Aspect 15, wherein: the non-coherent transmission capability is a default mode of transmission capability.

Aspect 17: The method of any one of Aspects 11 to 16, wherein: the first frequency includes a first plurality of frequencies: or the second frequency includes a second plurality of frequencies.

Aspect 18: The method of any one of Aspects 11 to 17, wherein a first UL TX chain of the UE is configured to transmit the first UL data using the first frequency; wherein a second UL TX chain of the UE is configured to: transmit the first UL data using the first frequency, transmit the second UL data using the second frequency, and switch from a first scheduled transmission of the first UL data to a second scheduled transmission of the second UL data or from the second scheduled transmission of the second UL data to the first scheduled transmission of the first UL data, wherein the switching maintains coherency in the second UL TX chain; and wherein the capability message indicates a partially coherent transmission capability or a fully coherent transmission capability for the UL TX switching coherence capability.

Aspect 19: The method of any one of Aspects 11 to 17, wherein a first UL TX chain of the UE is configured to transmit the first UL data using the first frequency; wherein a second UL TX chain of the UE is configured to: transmit the first UL data using the first frequency, transmit the second UL data using the second frequency, and switch from a first scheduled transmission of the first UL data to a second scheduled transmission of the second UL data or from the second scheduled transmission of the second UL data to the first scheduled transmission of the first UL data, wherein the switching causes a loss in coherency in the second UL TX chain; and wherein the capability message indicates a non-coherent transmission capability for the UL TX switching coherence capability.

Aspect 20: The method of any one of Aspects 11 to 19, further comprising: receiving, from the UE, an UL TX switching capability indicating whether a first UL TX chain or a second UL TX chain is configured for UL TX switching.

Aspect 21: A user equipment (UE), comprising: one or more processors, a memory comprising instructions executable by the one or more processers, and a transceiver, together configured to perform the operations of one or more of Aspects 1 to 10.

Aspect 22: A user equipment (UE), comprising means for performing the operations of one or more of Aspects 1 to 10.

Aspect 23: A computer-readable medium for wireless communications comprising instructions executable by a user equipment (UE) to perform the operations of one or more of Aspects 1 to 10.

Aspect 24: An apparatus for wireless communications by a user equipment comprising: a memory comprising instructions; and one or more processors configured to execute the instructions in the memory to: generate a capability message indicating a first coherence capability of a first frequency, a second coherence capability of a second frequency, and an uplink (UL) transmission (TX) switching coherence capability: output the capability message for transmission to a base station: obtain UL scheduling information for transmitting first UL data using the first frequency and second UL data using the second frequency; and output for transmission to the base station at least one of the first UL data or the second UL data based on the UL scheduling information and based on at least one of the first coherence capability, the second coherence capability, or the UL TX switching coherence capability.

Aspect 25: A base station, comprising: one or more processors, a memory comprising instructions executable by the one or more processers, and a transceiver, together configured to perform the operations of one or more of Aspects 11 to 20.

Aspect 26: A base station, comprising means for performing the operations of one or more of Aspects 11 to 20.

Aspect 27: A computer-readable medium for wireless communications comprising instructions executable by a base station to perform the operations of one or more of Aspects 11 to 20.

Aspect 28: An apparatus for wireless communications by a base station comprising: a memory comprising instructions; and one or more processors configured to execute the instructions in the memory to: obtain a capability message received from a user equipment (UE) indicating a first coherence capability of a first frequency, a second coherence capability of a second frequency, and an uplink (UL) transmission (TX) switching coherence capability: output, for transmission to the UE, UL scheduling information for transmitting, by the UE, first UL data using the first frequency and second UL data using the second frequency; and obtain at least one of the first UL data or the second UL data received from the UE based on the UL scheduling information and based on at least one of the first coherence capability, the second coherence capability, or the UL TX switching coherence capability.

Aspect 29: A user equipment (UE) comprising a processor and an interface, wherein the processor is configured to: generate a capability message indicating a first coherence capability of a first frequency, a second coherence capability of a second frequency, and an uplink (UL) transmission (TX) switching coherence capability: output, via the interface, the capability message for transmission to a base station: obtain, via the interface, UL scheduling information received from the base station for transmitting first UL data using the first frequency and second UL data using the second frequency; and output, via the interface, for transmission to the base station, at least one of the first UL data or the second UL data based on the scheduling information and based on at least one of the first coherence capability, the second coherence capability, or the UL TX switching coherence capability.

Aspect 30: A base station comprising a processor and an interface, wherein the processor is configured to: obtain, via the interface, a capability message received from a user equipment (UE) indicating a first coherence capability of a first frequency, a second coherence capability of a second frequency, and an uplink (UL) transmission (TX) switching coherence capability: output, via the interface, for transmission to the UE, UL scheduling information for transmitting, by the UE, first UL data using the first frequency and second UL data using the second frequency; and obtain, via the interface, at least one of the first UL data or the second UL data received from the UE based on the scheduling information and based on at least one of the first coherence capability, the second coherence capability, or the UL TX switching coherence capability.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. For example, changes may be made in the function and arrangement of elements discussed without departing from the scope of the disclosure. Also, various examples may omit, substitute, or add various procedures or components as appropriate. For instance, the methods described may be performed in an order different from that described, and various steps may be added, omitted, or combined. Also, features described with respect to some examples may be combined in other examples. In some instances, well-known structures and apparatuses are shown in block diagram form in order to avoid obscuring the concepts of the described examples.

It should be noted that the techniques described herein may be used for various wireless communication networks such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description herein, however, describes an LTE/LTE-A system or 5G system for purposes of example, and LTE terminology is used in much of the description below, although the techniques may be applicable other next generation communication systems.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially-programmed device, such as but not limited to a processor, a digital signal processor (DSP), an ASIC, a FPGA or other programmable logic device, a discrete gate or transistor logic, a discrete hardware component, or any combination thereof designed to perform the functions described herein. A specially-programmed processor may be a microprocessor, but in the alternative, the processor may be any conventional processor, controller, microcontroller, or state machine. A specially-programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above may be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that may be accessed by a general purpose or special purpose computer. By way of example, and not limitation, computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

1. A method of wireless communication by a user equipment (UE) in a network, comprising:
generating a capability message indicating a first coherence capability of a first frequency, a second coherence capability of a second frequency, and an uplink (UL) transmission (TX) switching coherence capability;
transmitting the capability message to a base station;
receiving UL scheduling information for transmitting first UL data using the first frequency and second UL data using the second frequency; and
transmitting at least one of the first UL data or the second UL data based on the UL scheduling information and based on at least one of the first coherence capability, the second coherence capability, or the UL TX switching coherence capability.

2. The method of claim 1, further comprising:
receiving, from the base station in response to the capability message, a configuration message indicating a non-coherent codebook for transmitting at least one of the first UL data or the second UL data; and
wherein transmitting comprises transmitting at least one of the first UL data or the second UL data using the non-coherent codebook.

3. The method of claim 1, further comprising:
receiving, from the base station in response to the capability message, a configuration message indicating a fully coherent codebook for transmitting at least one of the first UL data or the second UL data; and
wherein transmitting comprises transmitting at least one of the first UL data or the second UL data using the fully coherent codebook.

4. The method of claim 1, further comprising:
receiving, from the base station in response to the capability message, a configuration message indicating a partially coherent codebook for transmitting at least one of the first UL data or the second UL data; and
wherein transmitting comprises transmitting at least one of the first UL data or the second UL data using the partially coherent codebook.

5. The method of claim 1, wherein:
each of the first coherence capability, the second coherence capability, and the UL TX switching coherence capability includes a fully coherent transmission capability, a partially coherent transmission capability, or a non-coherent transmission capability.

6. The method of claim 5, wherein:
the non-coherent transmission capability is a default mode of transmission capability.

7. The method of claim 1, wherein:
the first frequency includes a first plurality of frequencies; or
the second frequency includes a second plurality of frequencies.

8. The method of claim 1, further comprising:
configuring a first UL TX chain to transmit the first UL data using the first frequency; and
configuring a second UL TX chain to:
transmit the first UL data using the first frequency,
transmit the second UL data using the second frequency, and
switch from a first scheduled transmission of the first UL data to a second scheduled transmission of the second UL data or from the second scheduled transmission of the second UL data to the first scheduled transmission of the first UL data, wherein the switching maintains coherency in the second UL TX chain;
wherein the capability message indicates a partially coherent transmission capability or a fully coherent transmission capability for the UL TX switching coherence capability.

9. The method of claim 1, further comprising:
configuring a first UL TX chain to transmit the first UL data using the first frequency; and
configuring a second UL TX chain to:
transmit the first UL data using the first frequency,
transmit the second UL data using the second frequency, and
switch from a first scheduled transmission of the first UL data to a second scheduled transmission of the second UL data or from the second scheduled transmission of the second UL data to the first scheduled transmission of the first UL data, wherein the switching causes a loss in coherency in the second UL TX chain;
wherein the capability message indicates a non-coherent transmission capability for the UL TX switching coherence capability.

10. The method of claim 1, further comprising:
generating a UL TX switching capability indicating whether a first UL TX chain or a second UL TX chain is configured for UL TX switching; and
transmitting the UL TX switching capability to the base station.

11. A user equipment (UE), comprising:
a memory comprising instructions;
one or more processors configured to execute the instructions in the memory to generate a capability message indicating a first coherence capability of a first frequency, a second coherence capability of a second frequency, and an uplink (UL) transmission (TX) switching coherence capability; and
a transceiver configured to:
transmit the capability message to a base station;
receive UL scheduling information for transmitting first UL data using the first frequency and second UL data using the second frequency; and
transmit at least one of the first UL data or the second UL data based on the UL scheduling information and based on at least one of the first coherence capability, the second coherence capability, or the UL TX switching coherence capability.

12. (canceled)

13. (canceled)

14. (canceled)

15. (canceled)

16. A method of wireless communication by a base station comprising:
receiving, from a user equipment (UE), a capability message indicating a first coherence capability of a first frequency, a second coherence capability of a second frequency, and an uplink (UL) transmission (TX) switching coherence capability;
transmitting, to the UE, UL scheduling information for transmitting, by the UE, first UL data using the first frequency and second UL data using the second frequency; and
receiving, from the UE, at least one of the first UL data or the second UL data based on the UL scheduling information and based on at least one of the first coherence capability, the second coherence capability, or the UL TX switching coherence capability.

17. The method of claim 16, further comprising:
transmitting, to the UE, in response to the capability message, a configuration message indicating a non-coherent codebook for transmitting at least one of the first UL data or the second UL data; and
wherein receiving at least one of the first UL data or the second UL data comprises receiving at least one of the first UL data or the second UL data using the non-coherent codebook.

18. The method of claim 16, further comprising:
transmitting, to the UE, in response to the capability message, a configuration message indicating a fully coherent codebook for transmitting at least one of the first UL data or the second UL data; and
wherein receiving at least one of the first UL data or the second UL data comprises receiving at least one of the first UL data or the second UL data using the fully coherent codebook.

19. The method of claim 16, further comprising:
transmitting, to the UE, in response to the capability message, a configuration message indicating a partially coherent codebook for transmitting at least one of the first UL data or the second UL data; and
wherein receiving at least one of the first UL data or the second UL data comprises receiving at least one of the first UL data or the second UL data using the partially coherent codebook.

20. The method of claim 16, wherein:
each of the first coherence capability, the second coherence capability, and the UL TX switching coherence capability includes a fully coherent transmission capability, a partially coherent transmission capability, or a non-coherent transmission capability.

21. The method of claim 20, wherein:
the non-coherent transmission capability is a default mode of transmission capability.

22. The method of claim 16, wherein:
the first frequency includes a first plurality of frequencies; or
the second frequency includes a second plurality of frequencies.

23. The method of claim 16,
wherein a first UL TX chain of the UE is configured to transmit the first UL data using the first frequency;
wherein a second UL TX chain of the UE is configured to:
transmit the first UL data using the first frequency,
transmit the second UL data using the second frequency, and
switch from a first scheduled transmission of the first UL data to a second scheduled transmission of the second UL data or from the second scheduled transmission of the second UL data to the first scheduled transmission of the first UL data, wherein the switching maintains coherency in the second UL TX chain; and
wherein the capability message indicates a partially coherent transmission capability or a fully coherent transmission capability for the UL TX switching coherence capability.

24. The method of claim 16,
wherein a first UL TX chain of the UE is configured to transmit the first UL data using the first frequency;
wherein a second UL TX chain of the UE is configured to:
transmit the first UL data using the first frequency,
transmit the second UL data using the second frequency, and
switch from a first scheduled transmission of the first UL data to a second scheduled transmission of the second UL data or from the second scheduled transmission of the second UL data to the first scheduled transmission of the first UL data, wherein the switching causes a loss in coherency in the second UL TX chain; and
wherein the capability message indicates a non-coherent transmission capability for the UL TX switching coherence capability.

25. The method of claim 16, further comprising:
receiving, from the UE, an UL TX switching capability indicating whether a first UL TX chain or a second UL TX chain is configured for UL TX switching.

26. (canceled)

27. (canceled)

28. (canceled)

29. (canceled)

30. (canceled)
